(19) United States
(12) Patent Application Publication
(10) Pub. No.: US 2025/0058217 A1
(43) Pub. Date: Feb. 20, 2025

(54) GAME VIDEO PLAYBACK

(71) Applicant: Tencent Technology (Shenzhen) Company Limited, Shenzhen (CN)

(72) Inventors: Lin HE, Shenzhen (CN); Zhiliang ZHEN, Shenzhen (CN)

(73) Assignee: Tencent Technology (Shenzhen) Company Limited, Shenzhen, GD (CN)

(21) Appl. No.: 18/934,177

(22) Filed: Oct. 31, 2024

Related U.S. Application Data
(63) Continuation of application No. PCT/CN2023/116771, filed on Sep. 4, 2023.

(30) Foreign Application Priority Data
Sep. 30, 2022 (CN) 202211208654.4

(51) Int. Cl. A63F 13/497; G06F 16/735

(52) U.S. Cl. CPC A63F 13/497; G06F 16/735

(57) ABSTRACT

In a method for playing a first game video, a video playing interface is displayed in a game application. Preview information of at least one game video of a game video library is displayed. The preview information includes description information that is determined based on an account tag of a user account and content of the first game video from the at least one game video. The account tag is determined based on game play activity information of the user account associated with the game application. Based on a user operation performed on the first game video from the at least one game video, the first game video is played in the video playing interface. Apparatus and non-transitory computer-readable storage medium counterpart embodiments are also contemplated.

### RELATED APPLICATIONS

The present application is a continuation of International Application No. PCT/CN2023/116771, filed on Sep. 4, 2023, which claims priority to Chinese Patent Application No. 202211208654.4, filed on Sep. 30, 2022. The entire disclosures of the prior applications are hereby incorporated by reference.

### FIELD OF THE TECHNOLOGY

In a game application, a user can learn a game operation by viewing a game video.

In the related art, the user usually needs to select a game video from a video list, so that the game video is played according to selection of the user. However, for different users, prompt information (such as a cover and a title) corresponding to the same game video in the video list is the same, and the prompt information is fixed and single.

### SUMMARY

Embodiments of this disclosure include a method, apparatus, and a non-transitory computer-readable storage medium for playing a game video. Examples of technical solutions in the embodiments of this disclosure may be implemented as follows:

An aspect of this disclosure provides a method for playing a first game video. A video playing interface is displayed in a game application. Preview information of at least one game video of a game video library is displayed. The preview information includes description information that is determined based on an account tag of a user account and content of the first game video from the at least one game video. The account tag is determined based on game play activity information of the user account associated with the game application. Based on a user operation performed on the first game video from the at least one game video, the first game video is played in the video playing interface.

An aspect of this disclosure provides an apparatus. The apparatus includes processing circuitry configured to display a video playing interface in a game application. The processing circuitry is configured to display preview information of at least one game video of a game video library. The preview information includes description information that is determined based on an account tag of a user account and content of a first game video from the at least one game video. The account tag is determined based on game play activity information of the user account associated with the game application. Based on a user operation performed on the first game video from the at least one game video, the processing circuitry is configured to play the first game video in the video playing interface.

An aspect of this disclosure provides a non-transitory computer-readable storage medium storing instructions which when executed by a processor cause the processor to perform any of the methods of this disclosure.

Technical solutions provided in the embodiments of this disclosure can have the following beneficial effects:

By displaying the preview information of the game video in the video playing interface, the preview information includes the personalized prompt information determined based on the account tag of the user account and the content of the game video. When the user preforms an operation on the game video according to the preview information, the game video may be played in the video playing interface. In the technical solutions provided in the embodiments of this disclosure, because the personalized prompt information is determined based on the account tag of the user account and the content of the game video, that is, for different user accounts with different account tags, the client generates and displays different personalized prompt information (even for the same game video) based on different account tags, instead of displaying the same prompt information, thereby improving display flexibility and rationality of the prompt information. In addition, the personalized prompt information may better prompt the user, be more relevant to the user, and give the user better viewing guidance, thereby helping improve user viscosity, and also enriching a display form of the preview information.

### BRIEF DESCRIPTION OF THE DRAWINGS

FIG. 1 is a schematic diagram of an implementation environment of a solution according to an embodiment of this disclosure.

FIG. 2 is a schematic diagram of a video playing interface according to an embodiment of this disclosure.

FIG. 3 is a flowchart of a method for playing a game video according to an embodiment of this disclosure.

FIG. 4 is a schematic diagram of a video playing interface according to another embodiment of this disclosure.

FIG. 5 is a flowchart of a method for playing a game video according to another embodiment of this disclosure.

FIG. 6 is a flowchart of a method for playing a game video according to another embodiment of this disclosure.

FIG. 7 is a schematic diagram of a method for switching a game video according to an embodiment of this disclosure.

FIG. 8 is a flowchart of a method for playing a game video according to another embodiment of this disclosure.

FIG. 9 is a flowchart of a method for playing a game video according to another embodiment of this disclosure.

FIG. 10 is a schematic diagram of a method for playing a game video according to an embodiment of this disclosure.

FIG. 11 is a schematic diagram of a method for playing a game video according to another embodiment of this disclosure.

FIG. 12 is a schematic diagram of a method for playing a game video according to another embodiment of this disclosure.

FIG. 13 is a block diagram of an apparatus for playing a game video according to an embodiment of this disclosure.

FIG. 14 is a block diagram of an apparatus for playing a game video according to another embodiment of this disclosure.

FIG. 15 is a structural block diagram of a terminal device according to an embodiment of this disclosure.

### DESCRIPTION OF EMBODIMENTS

To make the objectives, technical solutions, and advantages of this disclosure clearer, the following further describes implementations of this disclosure in detail with reference to the accompanying drawings.

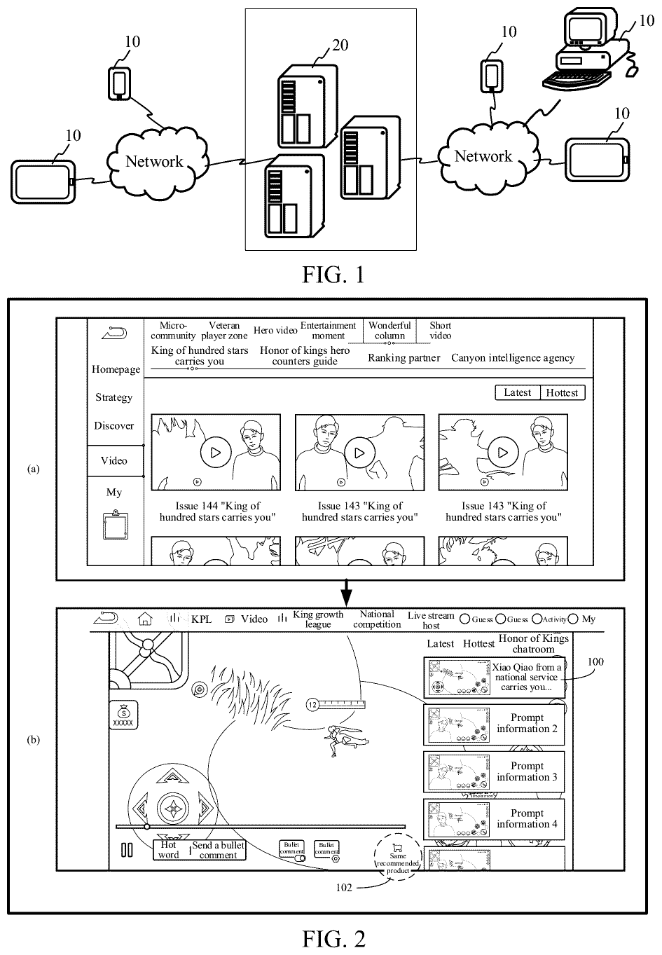

FIG. 1 is a schematic diagram of an implementation environment of a solution according to an embodiment of this disclosure. The implementation environment of the solution may be implemented as a playing system for a game video. The implementation environment of the solution may include: a terminal device 10 and a server 20.

The terminal device 10 may be an electronic device such as a mobile phone, a tablet computer, a game console, an ebook reader, a multimedia playback device, a wearable device, a personal computer (PC), a vehicle-mounted terminal, and an intelligent robot. A client of a target application (for example, a game application) may be installed in the terminal device 10. In some embodiments, the target application may be an application that needs to be downloaded and installed, or a tap-to-run application. This is not limited in this embodiment of this disclosure.

In this embodiment of this disclosure, the target application may be a game application, such as any one of a simulation program, a battle royale shooting game, a virtual reality (VR) application, an augmented reality (AR) program, a three-dimensional map program, a VR game, an AR game, a first-person shooting (FPS) game, a multiplayer shooting survival game, a third-person shooting (TPS) game, a multiplayer online battle arena (MOBA) game, and a simulation game (SLG). The target application may alternatively be any one of a social application and an interactive entertainment application. The target application may alternatively be any application with a video playing function. This is not limited in this embodiment of this disclosure. In this embodiment of this disclosure, a description is made by using an example in which the target application is the MOBA game application. In addition, a form or a shape and a corresponding function of the virtual object vary with different applications, and a virtual environment also varies with different applications, which may be designed according to an actual requirement. This is not limited in this embodiment of this disclosure. In some embodiments, a client of the target application runs in the terminal device 10.

The virtual environment is a scene displayed (or provided) when the client of the target application (such as a game application) runs on the terminal device. The virtual environment refers to a scene created for a virtual object to perform activities (such as game competition). The virtual scene is, for example, a virtual house, a virtual island, or a virtual map. The virtual environment may be a simulated environment of a real world, or may be a semi-simulated and semi-fictional environment, or may be a completely fictional environment. The virtual environment may be a two-dimensional virtual environment, a 2.5-dimensional virtual environment, or a three-dimensional virtual environment. This is not limited in this embodiment of this disclosure.

The virtual object may be a virtual character, a virtual vehicle, a virtual item, or the like controlled by a user account in the target application. This is not limited in this embodiment of this disclosure. For example, the target application is the MOBA game application. The virtual object may be a game character controlled by the user account in the game application. The virtual object may be in a human form or animal, cartoon, or other forms. This is not limited in this embodiment of this disclosure. The virtual object may be presented in a three-dimensional form or a two-dimensional form. This is not limited in this embodiment of this disclosure. In some embodiments, when the virtual environment is a three-dimensional virtual environment, the virtual object is a three-dimensional model created based on a skeletal animation technology. Each virtual object has a shape and size in the three-dimensional virtual environment, and occupies some space in the three-dimensional virtual environment. Activities of the virtual object include, but are not limited to, at least one of adjusting body postures, crawling, walking, running, riding, flying, jumping, driving, picking, shooting, attacking, and throwing. For example, the virtual object is a virtual character such as a simulated character role or a cartoon character role.

The server 20 is configured to provide a back-end service for the client of the target application that is installed and runs in the terminal device 10. For example, the server 20 may be a back-end server of the game application. The server 20 may be one server, a server cluster including a plurality of servers, or a cloud computing service center. In some embodiments, the server 20 simultaneously provides back-end services for clients of target applications in a plurality of terminal devices 10.

The terminal device 10 and the server 20 may communicate with each other through a network.

The method for playing the game video provided in this embodiment of this disclosure is described with reference to the foregoing introduction to the virtual environment and the virtual object, and the description of an implementation environment of the solution. An execution entity of the method may be a client running on the terminal device shown in FIG. 1. The client may be a client corresponding to the game application, and the game application supports video playing, for example, supports game video playing.

For example, an example in which the method for playing the game video provided in this disclosure is applied to the MOBA game application is used.

First, a brief description of the method for playing the game video in the MOBA game application is provided. As shown in a sub-figure a in FIG. 2, in the related art, the game video may also be played in the game application. The client starts playing the game video in response to a tapping operation of a user on the game video. In the related art, video content may be recommended based only on a historical viewing behavior of the user on a current platform. Data from a non-current platform cannot be obtained, and a lag in the data is heavy. Recommendations cannot be made following a current behavior change of the user in the game. By analyzing shortcomings of related technical solutions, to better provide the user with a video content recommendation and a viewing experience, the technical solution provided in this embodiment of this disclosure mainly aims to resolve a problem of “recommending the video content in real time according to the historical game behavior of the user”. As shown in a sub-figure b in FIG. 2, to achieve a better content experience, a recommendation algorithm is introduced in the technical solution provided in this embodiment of this disclosure, to determine a user tag not only through the historical viewing behavior of the user, but also through the historical game behavior of the user, such as tags including “preferring a middle lane” and “Player Xiao Qiao”, and label the user tag on a content recommendation and a goods recommendation in a form of personalized prompt information.

In this disclosure, a prompt interface, a pop-up window, or voice output prompt information may be displayed before collecting user-related data and in a process of collecting the user-related data. The prompt interface, the pop-up window, or the voice prompt information is configured for prompting the user that related data of the user is currently being collected, so that in this disclosure, related steps of obtaining the user-related data starts to be performed only after obtaining a confirmation operation of the user on the prompt interface or the pop-up window, or otherwise (that is, when the confirmation operation of the user on the prompt interface or the pop-up window is not obtained), the related steps of obtaining the user-related data are ended, that is, the user-related data is not obtained.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

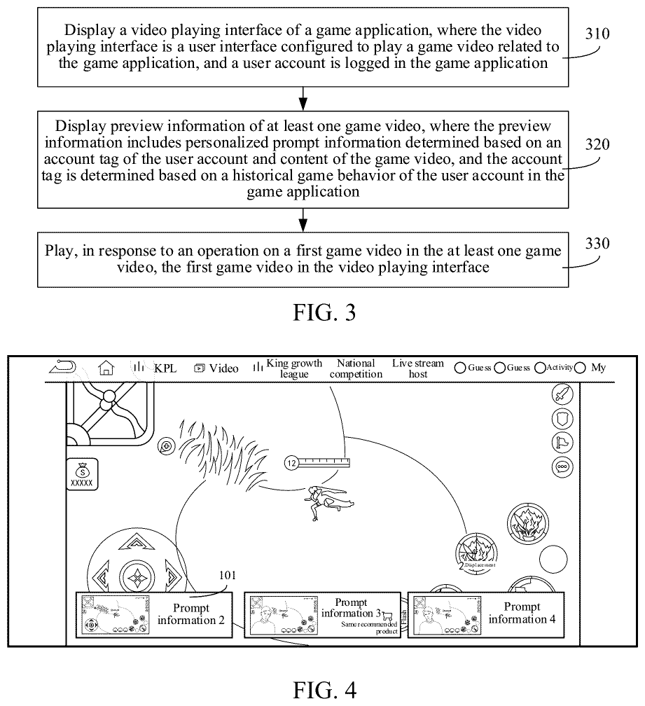

FIG. 3 is a flowchart of a method for playing a game video according to an embodiment of this disclosure. An execution entity of each step in the method may be the terminal device 10 in the implementation environment of the solution shown in FIG. 1. For example, the execution entity of each step may be a client of a target application in the terminal device 10. In the following method embodiment, for ease of description, a description is made by merely using a “client” as an execution entity of the steps. The method may include at least one of the following steps (310 to 330).

Step 310: Display a video playing interface of a game application, where the video playing interface is a user interface configured to play a game video related to the game application, and a user account is logged in the game application. For example, a video playing interface is displayed in a game application.

A type of the game application is not limited in this embodiment of this disclosure. The game application may be an online game application, may be an offline game application, may be a puzzle game application, may be a competitive game application, may be a single-player competitive game application, or may be a multiplayer competitive game application. Any game application that supports video playing may be included in the protection scope of the embodiments of this disclosure. In some embodiments, the user logs in to the game application through a user account. In some embodiments, the user logs in to the game application through different types of user accounts such as a social account, a shopping account, and a communication account. In some embodiments, the user may autonomously create a nickname, an avatar, and the like of an account. The user account may be configured for identifying the user in the game application.

The video playing interface refers to a user interface configured to play a video. The video playing interface in this embodiment of this disclosure may be configured to play the game video. In some embodiments, a playing size of the game video currently played in the video playing interface is not limited in this embodiment of this disclosure. For example, the currently played game video may be played in the video playing interface in a full-screen form, that is, an entire screen of the terminal device is configured to display content of the game video. In this embodiment of this disclosure, by playing the game video in full screen in the game playing interface, the user does not fail to view details of the game video due to a small playing size, thereby bringing a better viewing experience to the user.

In some other embodiments, the currently played game video may be played in the video playing interface in a non-full-screen form. For example, according to the following embodiments, preview information of another game video is further displayed in the video playing interface. In other words, the video playing interface needs to simultaneously play the game video and display the preview information of the another game video at a specific moment. Therefore, a specific display space may be left for the preview information by playing the currently played game video in the video playing interface in the non-full-screen form. For example, the game video is played on a left side of the video playing interface, and the preview information of the another game video is displayed on a right side of the video playing interface. This ensures that the current game video may be fully played while the preview information of the another game video is viewed. In some embodiments, the playing size of the game video in the video playing interface may be one-half of the screen size or one-quarter of the screen size. This is not limited in this embodiment of this disclosure. In the technical solution provided in this embodiment of this disclosure, by displaying the game video in non-full-screen in the video playing interface, the preview information of the another game video may be viewed, and playing integrity of the game video may be further ensured, so that a case that a video image is blocked and that affects the viewing experience does not occur. Therefore, the viewing experience of the user is also improved.

The game video in this embodiment of this disclosure is a game video in a broad sense, and any video related to game content may be referred to as a game video. In some embodiments, the game video includes a video image that is in a game battle and that is autonomously recorded by the user, and may be further accompanied by a game commentary, post-dubbing, and the like. In some embodiments, the game video may be a battle replay video autonomously saved by the user. In some embodiments, the game video is a video re-rendered by a server of the game application according to battle data of the user account. In some other embodiments, the game video is a video separately recorded and released by the server of the game application in some large competitions. In some embodiments, the game video is autonomously uploaded by the user to an official account of the game application. After being approved by the official account, the video is stored in the server of the game application, and may be viewed by other users. In other embodiments, the game video is autonomously recorded or rendered by the server of the game application, and is provided for other users for viewing.

In some embodiments, the game video may be used as a separate column of the game application for the user to tap and view when the user wants to learn a game operation. A position of the game application in which the game video is specifically set is not limited in this disclosure.

Step 320: Display preview information of at least one game video, where the preview information includes personalized prompt information determined based on an account tag of the user account and content of the game video, and the account tag is determined based on a historical game behavior of the user account in the game application. For example, preview information of at least one game video of a game video library is displayed. In an example, the preview information includes description information that is determined based on an account tag of a user account and content of the first game video from the at least one game video. For example, the account tag is determined based on game play activity information of the user account associated with the game application.

The preview information refers to information provided for the user to view and is related to the content of the game video, which allows the user to understand the game video in advance without viewing the game video. A display position of the preview information of the game video is not limited in this embodiment of this disclosure. In some embodiments, the preview information may be displayed at any position of the video playing interface, for example, including an upper area of the interface, a lower area of the interface, a left area of the interface, a right area of the interface, or a middle area of the interface. A display form of the preview information of the game video is not limited in this embodiment of this disclosure. In some embodiments, a font size, a picture size, and the like in the preview information may be uniformly set by the server, or may be autonomously adjusted by the user according to habits. A display effect of the preview information of the game video is not limited in this embodiment of this disclosure. In some embodiments, the preview information is displayed, in a fixed area in response to an operation of the user, in a manner of swiping up or down. In some embodiments, the preview information is displayed in a manner of scrolling in the video playing interface in a form of a bullet screen. Accordingly, in order not to affect the game video being played, the user may further set transparency of the preview information, and the like. A content architecture of the preview information is not limited in this embodiment of this disclosure. In some embodiments, the preview information includes but is not limited to at least one of the following: text, a picture, and the like.

The account tag refers to a tag configured for reflecting a behavior of the user account. The account tag may be determined based on the historical game behavior of the user account in the game application, or based on the historical viewing behavior of the user, or based on both the historical game behavior of the user account and the historical viewing behavior of the user. A quantity of account tags of the user account is not limited in this disclosure, for example, including at least one. The historical game behavior may refer to a game behavior of the user before a current moment, or may refer to a game behavior in a specific historical period. This is not limited in this embodiment of this disclosure.

In some embodiments, the account tag is determined based on the historical game behavior of the user account in the game application. The historical game behavior includes a quantity of days of playing the game, a quantity of times of using different virtual characters (such as game characters), a quantity of battles in different lanes, a quantity of battles in different maps, a quantity of times of using different skins, battle scores of different virtual characters, scores of kill, death, assist (KDA) in historical battles, a ratio of a quantity of battles played to obtain a most valuable player (MVP) to a total quantity of battles, a game wealth level, and the like. The historical game behavior is not limited in this embodiment of this disclosure. Any game behavior that is performed by the user and that is related to the game may be included in the protection scope of this embodiment of this disclosure.

For example, the account tag of the user account may be determined according to a quantity of game days corresponding to the user. For example, an account tag of a user account whose quantity of days of playing the game is greater than a first threshold is set as a senior player, and an account tag of a user account whose quantity of days of playing the game is less than a second threshold is set as a new player, where the first threshold is greater than the second threshold. In some embodiments, the account tag of the user account may also be determined according to a quantity of times of using different virtual characters corresponding to the user. For example, if a quantity of times of using a virtual character “Xiao Qiao” by the user account is the greatest in comparison to a quantity of times of using another virtual character, for example, a quantity of times of using the virtual character “Xiao Qiao” is up to 5,000, the account tag of the user account may be set to “Player Xiao Qiao”. In some embodiments, the account tag of the user account may also be determined according to a quantity of battles played by the user in different lanes. For example, if a quantity of battles played in the middle lane by the user account is the greatest in comparison to a quantity of battles played in other lanes (for example, a battle lane is divided into an upper lane, a middle lane, and a lower lane), the account tag of the user account may be set as “Player in a middle lane”. In some embodiments, the account tag of the user account may also be determined according to the scores of the KDA in the historical battles corresponding to the user. For example, if an average score of the KDA in the historical battles is greater than a third threshold, the account tag of the user account may be set as “Veteran player”, and if an average KDA score in the historical battles is less than a fourth threshold, the account tag of the user account may be set as “Rookie player”, where the third threshold is greater than the fourth threshold. In some embodiments, the account tag of the user account may also be determined according to the game wealth level corresponding to the user. For example, if a wealth level is greater than a first value, the account tag of the user account may be set as “Rich player”, and if a wealth level is less than a second value, the account tag of the user account may be set as “Ordinary player”, where the first value is greater than the second value. A specific setting manner of the account tag is not limited in this disclosure. In some feasible embodiments, in addition to being determined according to the historical game behavior of the user, the account tag may be further autonomously set by the user. For example, the user may set the account tag according to his own preference. A specific setting manner is not limited in this disclosure.

In some embodiments, the account tag is determined based on the historical viewing behavior of the user account in the game application. In some embodiments, the historical viewing behavior includes a style (such as a humorous type and a skill-improving type) of a game video that the user account likes, a battle moment (such as an early stage in a battle, a middle stage in a battle, and a late stage in a battle) of a game video that the user account likes to view, a releaser of a game video that the user account likes to view, a master virtual character in a game video that the user account likes to view, and the like. The master virtual character in this embodiment of this disclosure may refer to a virtual character used by a video releaser or sharer. In some game videos in which perspectives of the virtual character may be switched, the virtual character may be the master virtual character after the final switch.

The personalized prompt information in this embodiment of this disclosure refers to information that provides a targeted prompt for the user about the game video.

In some embodiments, the personalized prompt information is obtained by superimposing the account tag and the content of the game video. For example, if the account tag of the user is “Player Xiao Qiao”, and the content of the game video is “Xiao Qiao in a middle lane gives support in a timely manner, achieves a penta kill, and helps a team seal a victory”, the personalized prompt information may be “Player Xiao Qiao, and Xiao Qiao in a middle lane gives support in a timely manner, achieves a penta kill, and helps a team seal a victory”. A specific manner of superimposing the account tag and the content of the game video is not limited in this embodiment of this disclosure.

In some embodiments, the personalized prompt information is extracted according to the account tag and keywords of the content of the game video. For example, if the account tag of the user is “Player Xiao Qiao”, the content of the game video is “Xiao Qiao in a middle lane gives support in a timely manner, achieves a penta kill, and helps a team seal a victory”, and the keywords are “Xiao Qiao achieves a penta kill”, the personalized prompt information may be “Player Xiao Qiao, and Xiao Qiao achieves a penta kill”. A specific manner of extracting the keywords of the account tag and the content of the game video is not limited in this embodiment of this disclosure.

In some embodiments, the personalized prompt information is flexibly generated according to the account tag and the content related to the account tag in the game video. For example, if the account tag of the user is “Player Xiao Qiao” and the content of the game video is “Xiao Qiao in a middle lane gives support in a timely manner, achieves a penta kill, and helps a team seal a victory”, the personalized prompt information may be “Teach you how to achieve a penta kill as a player Xiao Qiao with case”. For another example, if the account tag of the user is “Player Ake”, and the content of the game video is “Ake surrounds the enemy from behind in stealth, and achieves a penta kill with a sliver of health”, the personalized prompt information may be “Teach you how to counter-kill the enemy with a sliver of health as a player Ake”. In some embodiments, a specific connection is established between the account tag and the content of the game video by using a template, and the personalized prompt information may be generated, according to the template set in advance, as required. Template content may be set in advance according to different account tags. When a tag of a corresponding type of appears, a corresponding template may be applied. A specific manner of generating the personalized prompt information according to the account tag and the content related to the account tag in the game video is not limited in this embodiment of this disclosure.

In this embodiment of this disclosure, the personalized prompt information for the user is generated according to the account tag of the user. In other words, if the user has different account tags, the personalized prompt information displayed to the user by the client is also different. The client does not recommend the same prompt information to the user. This helps improve rationality of generation of the prompt information, thereby increasing user viscosity.

In some embodiments, the personalized prompt information is displayed in a form of a recommendation tag of the game video. The recommendation tag refers to introduction information of the game video. For example, a plurality of recommendation tags is displayed in the video playing interface, and each recommendation tag corresponds to one recommended game video. A specific shape of the recommendation tag is not limited in this disclosure, and a position of the recommendation tag is not limited in this disclosure. For example, the personalized prompt information is displayed in a form of the recommendation tag (for example, a text description). The position of the recommendation tag may appear on a left side or a right side of a video title, or appear above or below a video title, or the like. The technical solution provided in the embodiments of this disclosure may intuitively prompt the user by displaying the game video in a manner of the recommendation tag that what are keywords corresponding to the game video, and what content is related to the user. Therefore, interaction efficiency between the user and the game video may be improved, thereby improving a conversion success rate of the game video, and an unimportant game video or a disliked game video may be quickly skipped, thereby improving efficiency of obtaining information.

In some embodiments, the personalized prompt information is displayed in a form of a video title of the game video. Because an account tag of each user account is different, the personalized prompt information also needs to be different for each user, when the personalized prompt information is displayed in a form of a title of the game video, a video title that each user views is different. This is because the personalized prompt information generated based on the account tag of the user replaces an original video title of the game video. In some embodiments, the client does not need to generate the title of the game video, but can directly display the personalized prompt information at a position of the title of the game video. In some other embodiments, a new video title may be generated with reference to the original video title of the game video and the personalized prompt information, to serve as content of the video title of the game video. For example, keywords may be extracted from the original video title of the game video, and the new video title is generated with reference to the personalized prompt information. In some embodiments, a plurality of pieces of personalized prompt information displayed in the form of the video title of the game video may be displayed in the video playing interface. The position of the personalized prompt information displayed in the form of the video title in the video playing interface is not limited in this disclosure. In the technical solution provided in this embodiment of this disclosure, the game video is displayed in a manner of the video title, which is more eye-catching and intuitive. This helps the user determine whether the game video is a game video that the user likes to view, thereby improving the efficiency of obtaining information.

In some embodiments, the personalized prompt information is displayed in a form of a preview of the game video. In this embodiment of this disclosure, the preview may be a picture that is preset by the terminal device or the server and that is unrelated to specific game content. The preview may also be a picture determined based on the specific game content. In some embodiments, the preview may be accompanied by text, a meme, a picture, and the like. In some embodiments, a video image related to the personalized prompt information in the game content may be intercepted and used as a preview of the game video, to be displayed in the video playing interface. For example, if the personalized prompt information is “Teach you how to counter-kill the enemy with a sliver of health as a player Ake”, a video image that Ake escapes with a sliver of health may be intercepted and used as a preview, to attract more users' attention. In the technical solution provided in this embodiment of this disclosure, the game video is displayed in the manner of the preview, which is vivid and interesting, can attract more users' attention, and can also give the user a richer experience with the game video.

In this embodiment of this disclosure, the foregoing personalized prompt manners may be in combination, or in a separate manner. For example, the personalized prompt information may be displayed in a form of “tag+title+preview”, or the personalized prompt information may be displayed in a form of “tag+title”, or the personalized prompt information may be displayed in a form of “title+preview”. A specific combination manner is not limited in this disclosure. In other words, for different account tags, recommendation tags may be different, video titles may also be different, and previews may also be different. This is not limited in this embodiment of this disclosure.

For example, as shown in the sub-figure b in FIG. 2, the personalized prompt information 100 is displayed on a right side of the video playing interface in a form of a video title and a preview. For another example, as shown in FIG. 4, the personalized prompt information 101 is displayed on a lower side of the video playing interface in a form of a video title and a preview. A display position of the personalized prompt information is not limited in this embodiment of this disclosure. The personalized prompt information may be displayed at any position in the video playing interface, and may be displayed in a complete form or in an abbreviated form.

Step 330: Play, in response to an operation on a first game video in the at least one game video, the first game video in the video playing interface. For example, based on a user operation performed on the first game video from the at least one game video, the first game video is played in the video playing interface.

An operation may refer to an operation performed by the user on a game application, such as an operation performed through a touch screen of a terminal device, or an operation performed through an external device (such as a mouse, a keyboard, or a handle) of the terminal device.

The operation may be configured for playing a first game video. In an example, the operation may be a trigger operation for the personalized prompt information, for example, including but not limited to, operations for the personalized prompt information such as tapping, double-tapping, touch-and-hold, an operation on a key, and a gesture. A specific operation type is not limited in this disclosure.

The first game video may refer to any game video among at least one game video. The first game video may be played in a full-screen manner or in a non-full-screen manner in the video playing interface. A specific playing manner is not limited in this disclosure. For detailed discussion of the playing manner, refer to step 320. This is not described herein again. In some embodiments, the user may further adjust the playing manner (for example, a playing size) of the game video. This is not limited in this embodiment of this disclosure.

In the technical solution provided in this embodiment of this disclosure, by displaying the preview information of the game video in the video playing interface, the preview information includes the personalized prompt information determined based on the account tag of the user account and the content of the game video. When the user preforms an operation on the game video according to the preview information, the game video may be played in the video playing interface. In the technical solutions provided in the embodiments of this disclosure, because the personalized prompt information is determined based on the account tag of the user account and the content of the game video, that is, for different user accounts with different account tags, the client generates and displays different personalized prompt information (even for the same game video) based on different account tags, instead of displaying the same prompt information, thereby improving display flexibility and rationality of the prompt information. In addition, the personalized prompt information may better prompt the user, be more relevant to the user, and give the user better viewing guidance, thereby helping improve user viscosity, and also enriching a display form of the preview information.

In addition, in response to the operation on the personalized prompt information of the first game video, the first game video may be played in the video playing interface. A case in which the video playing interface is exited each time after the game video is played, and after a video is reselected, the video playing interface is entered again to play the video is avoided, thereby simplifying a playing operation of the user, and improving selection efficiency of the video. This helps improve the video viewing experience of the user.

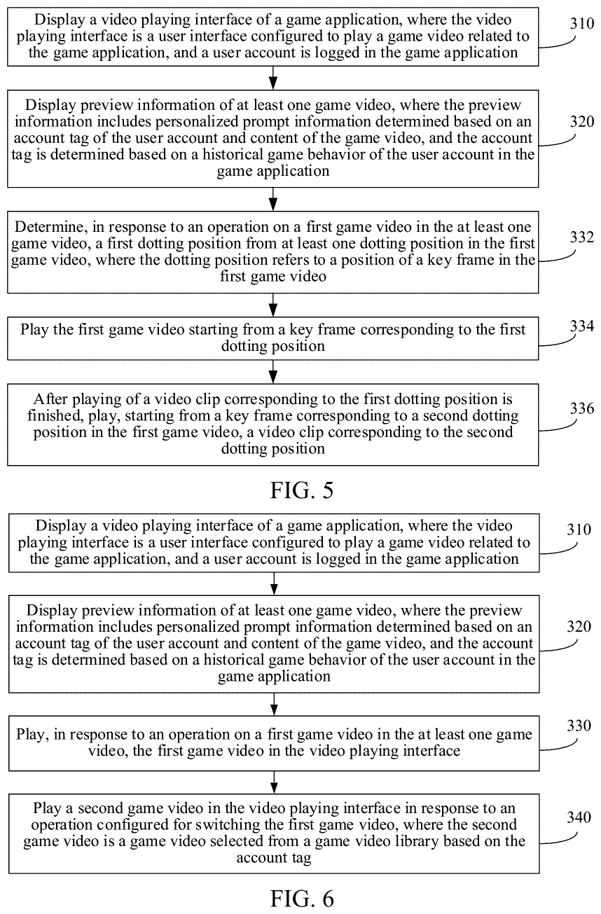

FIG. 5 is a flowchart of a method for playing a game video according to another embodiment of this disclosure. An execution entity of each step in the method may be the terminal device 10 in the implementation environment of the solution shown in FIG. 1. For example, the execution entity of each step may be a client of a target application in the terminal device 10. In the following method embodiment, for case of description, a description is made by merely using a “client” as an execution entity of the steps. The method may include at least one of the following steps (310 to 336).

Step 310: Display a video playing interface of a game application, where the video playing interface is a user interface configured to play a game video related to the game application, and a user account is logged in the game application. For example, a video playing interface is displayed in a game application.

Step 320: Display preview information of at least one game video, where the preview information includes personalized prompt information determined based on an account tag of the user account and content of the game video, and the account tag is determined based on a historical game behavior of the user account in the game application. For example, preview information of at least one game video of a game video library is displayed. In an example, the preview information includes description information that is determined based on an account tag of a user account and content of the first game video from the at least one game video. For example, the account tag is determined based on game play activity information of the user account associated with the game application.

Step 310 and step 320 are the same as those introduced in the foregoing embodiments. For content not described in this embodiment of this disclosure, refer to the foregoing embodiments. This is not described herein again.

Step 332: Determine, in response to an operation on a first game video in the at least one game video, a first dotting position from at least one dotting position in the first game video, where the dotting position refers to a position of a key frame in the first game video. For example, a first key frame from at least one key frame in the first game video is determined.

The foregoing key frame may refer to a start frame of a video clip corresponding to a wonderful operation, or may refer to a start frame of a video clip including a game battle, or may refer to a start frame of an operation teaching clip. This is not limited in this embodiment of this disclosure. The dotting position may refer to a timestamp corresponding to the game video, for example, a timestamp corresponding to the key frame.

In some embodiments, the dotting position is determined based on content of the game video. For example, a highlight moment point or a teaching moment point in the game video may be used as the dotting position. The highlight moment point may be a point in the game video in which the virtual character performs very well, including but not limited to a penta-kill moment, a legendary moment, a baron-stealing moment, an inhibitor-stealing moment, and the like. The teaching moment point may include two aspects. a positive teaching moment point, and a negative teaching moment point. The positive teaching moment point correspondingly includes content that provides positive guidance for the user, such as how to participate in a team fight, how to turn the table, how to steal a baron, how to steal an inhibitor, and the like. The negative teaching moment point correspondingly includes a negative teaching material configured for guiding the user to avoid such behaviors, such as not participating in a team fight, using a skill at a wrong occasion, and entering into the team fight at a wrong entry point. A specific type of the dotting position is not limited in this disclosure.

In some embodiments, the dotting position is determined based on the account tag. For example, a position (for example, a timestamp) of content related to the account tag in the game video may be used as the dotting position. For example, if the account tag of the user is “Player Xiao Qiao”, positions of the video content related to Xiao Qiao in the game video may be considered as dotting positions. The dotting positions determined based on the account tag may be considered as positions that the user is interested in. This helps improve the user viscosity.

In some embodiments, the dotting position is determined based on the content of the game video and the account tag. For example, if the account tag of the user is “Player Xiao Qiao”, a position of a highlight moment point or a teaching moment point corresponding to the virtual character “Xiao Qiao” in the game video may be pulled out as the dotting position.

In some embodiments, each dotting position corresponds to one video frame. For example, the foregoing dotting position may be a start position or a middle position of a highlight clip or a teaching clip. The highlight clip or the teaching clip lasts for a period of time, and specific duration corresponding to the highlight clip or the teaching clip needs to be determined according to the content of the video. Duration of a video clip corresponding to the highlight clip or the teaching clip may also be manually set. For example, a video clip that starts from the dotting position and lasts for second duration may be determined as a video clip corresponding to the dotting position. The second duration may be set and adjusted according to an actual usage requirement. For example, the second duration may be 2 minutes or 3 minutes. In a case in which the second duration is 3 minutes, a video clip that starts from the dotting position and lasts for 3 minutes may be determined as the video clip corresponding to the dotting position.

In some embodiments, a first dotting position may be determined from a plurality of dotting positions in a first order. In some embodiments, the first order is a time order. According to timestamps of different dotting positions in the game video, the dotting positions are sorted in an order of time points, and then a dotting position with an earliest time point may be determined as the first dotting position. In some embodiments, the first order is an order of a degree of brilliance of the dotting positions. The degree of brilliance of different dotting positions may be scored in a form of values or weights, and the dotting positions may be sorted in an order of the scores of the dotting positions. Then, a dotting position with a highest score may be determined as the first dotting position. In some embodiments, the first order is an order of a degree of correlation between content information of the dotting positions and the account tag. The degree of correlation between different dotting positions and the account tag may be determined, and a dotting position with a high degree of correlation is used as the first dotting position. A manner of determining the first dotting position is not limited in this embodiment of this disclosure.

In some embodiments, step 332 further includes step 332-1 (not shown in the figure).

Step 332-1: Select, according to content information of each dotting position in the first game video, a dotting position that matches the account tag as the first dotting position, where the content information indicates content of a video clip corresponding to the dotting position. For example, a key frame is selected as the first key frame from the at least one key frame that matches the account tag based on content information of each of the at least one key frame in the first game video.

There may be a plurality of dotting positions in the first game video, and content information at different dotting positions are different. Some may be content corresponding to the highlight moment point, some may be content corresponding to the teaching moment point, and some may be content corresponding to a position that matches the account tag. In some embodiments, a dotting position that matches the account tag may be determined as the first dotting position. In some embodiments, there may be a plurality of dotting positions that match the account tag. In some embodiments, according to a difference in a degree of matching between different dotting positions and account tags, a dotting position with a highest degree of matching to the account tag is determined from the plurality of dotting positions that match the account tag as a first dotting position.

In some embodiments, algorithms such as cosine similarity, a Euclidean distance, and a Manhattan distance may be used, to determine whether the dotting position matches the account tag, or to determine the degree of matching between the dotting position and the account tag. This is not limited in this embodiment of this disclosure. For example, the foregoing method may be used to calculate, based on the content information of the dotting position and the account tag, the degree of matching between the dotting position and the account tag.

Step 334: Play the first game video starting from a key frame corresponding to the first dotting position. For example, the first game video from the first key frame is played.

In other words, the client does not need to start playing from a first frame of the game video, but can directly jump to the key frame corresponding to the first dotting position to start playing. In this way, the user may quickly obtain content that the user may be interested in, thereby improving the efficiency of obtaining information.

Step 336: After playing of the video clip corresponding to the first dotting position is finished, play, starting from a key frame corresponding to a second dotting position in the first game video, a video clip corresponding to the second dotting position. For example, a second video segment corresponding to the second key frame in the first game video from the second key frame is played while skipping intervening video content between the first key frame and the second key frame.

In some embodiments, determining of the second dotting position is similar to determining of the first dotting position. For example, a second dotting position may be determined from a plurality of dotting positions in a first order. In some embodiments, the first order is a time order. According to timestamps of different dotting positions in the game video, in an order of time points, a dotting position with an earliest time point may be determined as the first dotting position, and a time point at a next dotting position after the first dotting position may be determined as the second dotting position. In some embodiments, the first order is an order of a degree of brilliance of the dotting positions. The degree of brilliance of different dotting positions may be scored in a form of values or weights. According to an order of scoring the dotting positions, a dotting position with a highest score is determined as the first dotting position, and a next dotting position whose score is after the first dotting position is determined as the second dotting position. In some embodiments, the first order is an order of a degree of correlation between content information of the dotting positions and the account tag. The degree of correlation between different dotting positions and the account tag is determined. A dotting position with a high degree of correlation is used as the first dotting position, and a next dotting position whose degree of correlation is after the first dotting position is determined as the second dotting position. A manner of determining the second dotting position is not limited in this embodiment of this disclosure.

The technical solution provided in this embodiment of this disclosure allows the user to quickly obtain content that the user may be interested in by directly jumping to the key frame corresponding to the first dotting position to start playing, thereby improving the efficiency of obtaining information. In addition, directly jumping to a next dotting position for playing after playing at one dotting position is finished may save time of the user in viewing videos. For some users who do not have a lot of time to study the game video, this disclosure may improve playing efficiency of the game video, thereby further improving the efficiency of obtaining information.

In addition, by selecting, according to the account tag, the first dotting position from the plurality of dotting positions in the game video for playing, different video clips in the same game video may be played according to different requirements of different users, making playing of the game video more targeted and instructive, thereby improving rationality of playing of the game video.

FIG. 6 is a flowchart of a method for playing a game video according to another embodiment of this disclosure. An execution entity of each step in the method may be the terminal device 10 in the implementation environment of the solution shown in FIG. 1. For example, the execution entity of each step may be a client of a target application in the terminal device 10. In the following method embodiment, for ease of description, a description is made by merely using a “client” as an execution entity of the steps. The method may include at least one of the following steps (310 to 340).

Step 310: Display a video playing interface of a game application, where the video playing interface is a user interface configured to play a game video related to the game application, and a user account is logged in the game application. For example, a video playing interface is displayed in a game application.

Step 320: Display preview information of at least one game video, where the preview information includes personalized prompt information determined based on an account tag of the user account and content of the game video, and the account tag is determined based on a historical game behavior of the user account in the game application. For example, preview information of at least one game video of a game video library is displayed. In an example, the preview information includes description information that is determined based on an account tag of a user account and content of the first game video from the at least one game video. For example, the account tag is determined based on game play activity information of the user account associated with the game application.

Step 330: Play, in response to an operation on a first game video in the at least one game video, the first game video in the video playing interface. For example, based on a user operation performed on the first game video from the at least one game video, the first game video is played in the video playing interface.

Step 310 to step 330 are the same as those introduced in the foregoing embodiments. For content not described in this embodiment of this disclosure, refer to the foregoing embodiments. This is not described herein again.

Step 340: Play a second game video in the video playing interface in response to an operation configured for switching the first game video, where the second game video is a game video selected from a game video library based on the account tag.

The foregoing operation may refer to a switching operation of a user for the first game video. The switching operation is configured for canceling playing of the first game video in the video playing interface, and playing the second game video. The second game video may refer to a game video selected by the user from the at least one game video, and the second game video is different from the first game video. The at least one game video may be obtained, according to an account tag of the user, by filtering by the client from the game video library, such as recommending a game video that matches the account tag in the game video library to the user. The game video library may refer to a video library corresponding to the foregoing game application, which may store a game video related to the game application.

In some embodiments, the switching operation is a direct operation on the first game video. In some embodiments, the switching operation includes but is not limited to at least one of the following: a swiping-up operation, a swiping-down operation, a swiping-left operation, and a swiping-right operation for the first game video, a tapping operation for a specific button, and a special gesture (for example, two-finger swiping) for the first game video. The technical solution provided in this embodiment of this disclosure plays the second game video in response to the switching operation of the user on the first game video, making switching between the first game video and the second game video simple and fast. The user does not need to select from a video list again, thereby saving time of the user in selecting videos, and improving efficiency of video switching.

In some other embodiments, the switching operation includes at least one of the following: a tapping operation on the first game video, an operation on the video list, and an operation on the personalized prompt information. For example, the user performs a tapping operation on the first game video played in the video playing interface. The client displays a video list (for example, including a part from the at least one game video) in the video playing interface in response to the tapping operation of the user, or displays the personalized prompt information. According to the video list information or the personalized prompt information, the user taps a next game video or the personalized prompt information that the user wants to play, and the client plays the second game video in the video playing interface. In the technical solution provided in this embodiment of this disclosure, the personalized prompt information may be summoned through the tapping operation on the first game video, and the second game video may be selected, based on the personalized prompt information, for playing. When the first game video recommended to the user does not meet a requirement of the user, the user may effectively change a recommended video in this manner. The client may also change a video that may be subsequently recommended to the user, so that the user may view a video that the user wants to view, thereby also improving accuracy of recommendation of subsequent game videos.

In some embodiments, when duration of playing the first game video is greater than first duration (for example, 5 s), if the client does not detect an operation signal generated by the user, the personalized prompt information automatically disappears. After the personalized prompt information disappears, the client displays the personalized prompt information again in response to the tapping operation of the user on the first game video, thereby implementing awakening of the personalized prompt information.

In some embodiments, after playing of the first game video is finished, if the user does not perform any operation on the first game video, a next game video is played by default. The next game video may be determined according to the account tag of the user account and a historical viewing behavior.

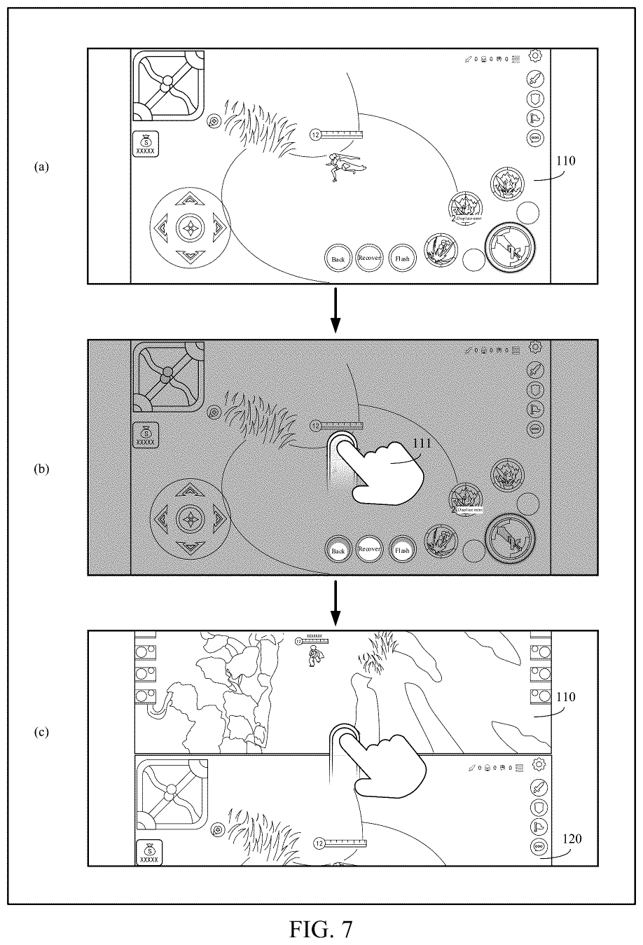

For example, FIG. 7 is a schematic diagram of a method for switching a game video according to an embodiment of this disclosure. As shown in a sub-figure a in FIG. 7, a client plays a first game video 110 in a video playing interface, and a sub-figure b in FIG. 7 shows guidance of a switching operation. In some embodiments, if a user performs a switching operation for the first time, the client provides guidance for the user by displaying a switching gesture 111. A sub-figure c in FIG. 7 shows that after the user performs, according to the switching gesture 111, the switching operation, the first game video 110 played in the video playing interface is switched to a second game video 120.

In some embodiments, the second game video is a game video selected from a game video library based on an account tag. In some embodiments, the second game video is a game video that the user manually selects according to personalized prompt information. For example, by tapping the personalized prompt information corresponding to the second game video, selection of the second game video may be implemented. In this case, the selection of the second game video has uncertainties, thereby improving fun of playing the game video. In some other embodiments, the second game video is a game video selected by a terminal device from the game video library based on the account tag. In other words, the client directly displays, in response to a direct operation of the user on the first game video, the second game video determined by the terminal device in the video playing interface.

In some embodiments, the terminal device determines the second game video according to the account tag and the game video in the game video library. For example, the client determines a recommendation score of each game video in the game video library according to the account tag and a video tag of the game video in the game video library, and uses a game video with a highest recommendation score of the game video in the video library as the second game video. Refer to the following embodiments for a specific manner of determining the recommendation score. This is not described herein again.

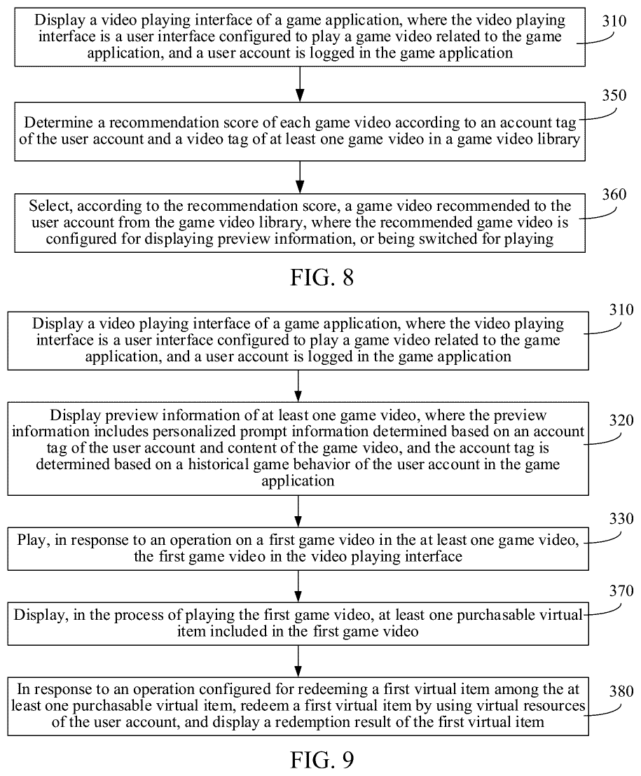

FIG. 8 is a flowchart of a method for playing a game video according to another embodiment of this disclosure. An execution entity of each step in the method may be the terminal device 10 in the implementation environment of the solution shown in FIG. 1. For example, the execution entity of each step may be a client of a target application in the terminal device 10. In the following method embodiment, for ease of description, a description is made by merely using a “client” as an execution entity of the steps. The method may include at least one of the following steps (310 to 360).

Step 310: Display a video playing interface of a game application, where the video playing interface is a user interface configured to play a game video related to the game application, and a user account is logged in the game application. For example, a video playing interface is displayed in a game application.

Step 310 is the same as those introduced in the foregoing embodiments. For content not described in this embodiment of this disclosure, refer to the foregoing embodiments. This is not described herein again.

Step 350: Determine a recommendation score of each game video according to the account tag of the user account and a video tag of at least one game video in the game video library. For example, the recommendation scores for the plurality of game videos are determined based on the adjusted plurality of account tags, the plurality of weight values, and the video information associated with the plurality of game videos in the game video library.

The video tag refers to a tag configured for representing the game video, which may indicate content, a type, and the like of the game video. In some embodiments, the video tag may be determined according to content related to the game in the game video. In some embodiments, the video tag may be determined according to content related to the video in the game video. In some feasible examples, a same rule as the account tag may be used to construct the video tag. For example, if a game video is related to a game character, a video tag of the game video may be the game character.

In some embodiments, the video tag may be determined according to content related to the game in the game video. The content related to the game may include at least one of the following: a game map in the game video, a master virtual character, a character type to which the master virtual character belongs, and a lane taken by the master virtual character. In some embodiments, the video tag is determined according to the game map in the game video. For example, the game map in the game video is “Flaming mountain”, and then a name of the game map may be directly used as the video tag, that is, the video tag is “Flaming mountain”. Certainly, a related video tag may also be generated according to the name of the game map. For example, the video tag may be “Battle in the flaming mountain”, and the like. In some embodiments, the video tag is determined according to the master virtual character in the game video. For example, the master virtual character in the game video is “Xiao Qiao”, the name of the master virtual character may be directly used as the video tag, that is, the video tag is “Xiao Qiao”. Certainly, a related video tag may also be generated according to the name of the master virtual character. For example, the video tag may be “Jungle Xiao Qiao”, and the like. In some embodiments, the video tag is determined according to the character type of the master virtual character in the game video. For example, the master virtual character in the game video is “Xiao Qiao”, belongs to a “Mage” type, and then the type of the master virtual character may be directly used as the video tag, that is, the video tag is “Mage”. Certainly, a related video tag may also be generated according to the type of the master virtual character. For example, the video tag may be “Top mage”, and the like. In some embodiments, the video tag is determined according to the lane taken by the master virtual character in the game video. For example, the master virtual character in the game video is “Xiao Qiao”, a lane taken by Xiao Qiao is a “Middle lane”, and then the “Middle lane” taken by the master virtual character may be directly used as the video tag, that is, the video tag is “Middle lane”. Certainly, a related video tag may also be generated according to the lane taken by the master virtual character. For example, the video tag may be “Brawl in the middle lane”, and the like. Certainly, the video tag may also be determined according to other game content. Information related to the content of the game may be used as the video tag. The video tag may be further determined according to content at a highlight moment of the game in the game video, such as “Kill little Luban in one move”, “Extreme home guard”, and the like.

In some embodiments, the video tag may be determined according to content related to the video in the game video. The content related to the video may include at least one of the following: a length of the video, post-dubbing of the video, post-commentary of the video, and text or a picture added in the video in a late stage. In some embodiments, the video tag is determined according to duration of the video. For example, for a game video whose duration is greater than a fifth threshold, a video tag of the game video may be “Long video”, and for a game video whose duration is less than a sixth threshold, a video tag of the game video may be “Short video”, where the fifth threshold is greater than the sixth threshold, and the fifth threshold and the sixth threshold may be set and adjusted according to an actual usage requirement. In some embodiments, the video tag is determined according to post-dubbing or post-commentary of the video, for example, the video tag is determined according to a style of the commentary, if a tone or wording of the commentary is humorous, the video tag may be considered as “Funny”. If the tone or wording of the commentary is serious teaching, the video tag may be considered “Teaching”. In addition, the video tag may be further determined according to a type of voice of the commentary. The video tag may be “Loli voice”, “Youth voice”, and the like separately.

A quantity of video tags is at least one, and a quantity of displayed video tags may be determined according to setting of the user or setting of the terminal device. For example, the video tag may also be labeled by the user. After viewing a video, the user tags the video. For example, the tag may be “dislike”, “like”, “giving a like”, “favorite”, or the like, or may be a tag targeting specific game content, such as “a real veteran player”, and the like. A manner in which the user sets the tag is not limited in this disclosure. For example, the manner may be a labeling operation on the game video, that is, the user may tag the game video through the labeling operation.

In some embodiments, the recommendation score of each game video may be determined according to correlation between the account tag of the user account and the video tag of the game video. The correlation may be considered as a degree of overlap or a degree of similarity. If the account tag of the user account is the same as or similar to the video tag of the game video, it may be determined that the game video is a video that the user wants to view, has a high degree of correlation, and has a high recommendation score. If the account tag of the user account is different from or not similar to the video tag of the game video, it may be determined that the game video is not a video that the user wants to view, has a low degree of correlation, and has a low recommendation score.

In some embodiments, if the account tag changes, a dotting position also changes accordingly. If the video tag changes, a dotting position also changes accordingly. For example, if the account tag changes, a key frame corresponding to the account tag also changes accordingly, which further causes a dotting position corresponding to the key frame to change. In this way, the dotting position may be automatically adjusted according to the account tag, which helps improve rationality of generation of the dotting position, thereby improving adaptability between the dotting position and the user, and increasing user viscosity.

A specific manner of determining the recommendation score is not limited in this embodiment of this disclosure. In some embodiments, a calculation model for a recommendation score of a game video is trained through a machine learning algorithm, a neural network algorithm, and the like. The calculation model uses the account tag and the video tag as an input, and uses the recommendation score as an output. In some embodiments, before calculating the recommendation score, a tag most related to the account tag may be uniquely determined, through a matching algorithm such as a Hungarian matching algorithm, from at least one video tag as a final video tag of the game video.

The recommendation score or weight in this embodiment of this disclosure may be determined by the terminal device, or by the client of the game application running on the terminal device, or by a server of the game application. A specific entity for determining the recommendation score is not limited in this disclosure. In addition, an entity for determining the account tag, the video tag, a weight of the account tag, or a weight of the video tag may also be determined by the terminal device, or by the client of the game application running on the terminal device, or by the server of the game application. In some embodiments, in a case in which the recommendation score, the tag, or the weight is determined by the server, the server sends the information to the client, and the client displays or processes the information.

Step 360: Select, from the game video library according to the recommendation score, a game video recommended to the user account, where the recommended game video is configured for displaying preview information, or being switched for playing. For example, at least one recommended game video from the game video library is selected based on the recommendation scores. The preview information for the selected at least one recommended game video is displayed in the video playing interface.

Referring to the foregoing embodiments, the recommended game videos may be displayed in the video playing interface in response to a switching operation of the user, or the preview information may be displayed in response to an operation of pulling the preview information for the currently played game video, where the preview information corresponds to the recommended game video. The operation of pulling the preview information may also refer to an operation of pulling a list of a game video. The operation may be tapping, touch-and-hold, a gesture, a key, and the like. This is not limited in this embodiment of this disclosure. In some embodiments, if it is detected that duration in which the user does not perform an operation on the video currently played in the video playing interface reaches a seventh threshold, the client cancels displaying the preview information, and the client displays the preview information in response to the operation of pulling the preview information for the video being played.

In some embodiments, a quantity of account tags is more than one, and the account tags have corresponding weight values.

The weight value in this embodiment of this disclosure is configured for representing the correlation between the account tag and the user account. The higher the weight value, the more related the account tag is to the user account. The weight value may be set in advance and be fixed, or may vary with a historical game behavior and a historical viewing behavior of the user. This is not limited in this embodiment of this disclosure.

In some embodiments, step 360 further includes step 360-1 (not shown in the figure).

Step 360-1: Determine the recommendation score of each game video according to the account tag of the user account, the weight value respectively corresponding to each account tag, and the video tag of the at least one game video in the game video library. For example, the recommendation scores for the plurality of game videos are determined based on the adjusted plurality of account tags, the plurality of weight values, and the video information associated with the plurality of game videos in the game video library.

In some embodiments, different weight values may be set for account tags of different types. For example, a weight value of a tag type “Virtual character” may be set to a highest value, and a weight value of a tag type “Wealth level” is set to a lowest value, thereby determining a weight value of each account tag of the user account.

In some embodiments, a game video, in the game video library, whose video tag is the same as or similar to any account tag is pulled out, to obtain a plurality of game videos related to the account tag of the user account. The weight value of the game video is determined according to the weight value of the account tag. In some embodiments, the video tags in the game video are “Middle lane” and “Veteran player”, and the account tag is “Middle lane”. If the two tags overlap with each other in the tag type “Lane”, the game video is filtered out. Because a weight value of the tag type “Lane” is set to 0.8, it may be determined that the recommendation score of the game video is 80 points. In some other embodiments, there may be a plurality of video tags in one game video that overlap with or are similar to the account tag, and weight values of different account tags may be used as parameters for weighting, to obtain the recommendation score of the game video. In some embodiments, video tags in the game video are “Middle lane”, “Veteran player”, and “Funny”, while account tags are “Middle lane” and “Humor”. If the two tags overlap with or are similar to the two tag types “Lane” and “Style”, the game video is filtered out. Because a weight value of the tag type “Lane” is set to 0.8, and a weight value of the tag type “Style” is set to 0.4, the recommendation score of the game video is that 100*0.8+100*0.4*0.2=88 points, where the parameter 0.2 may be set in advance, and may be obtained by model training.

In some embodiments, different weight values are set for video tags of different types. For example, a weight value of a tag type “Virtual character” may be set to a highest value, and a weight value of a tag type “Video duration” is set to a lowest value, thereby determining a weight value of each video tag of the game video.

In some embodiments, the recommended game video may be determined with reference to the weight value of the account tag and the weight value of the video tag. For example, the recommendation score of the game video is determined according to a sum of the weight value of the account tag and the weight value of the video tag, and then the recommended game video is determined according to the recommendation score of the game video.

In some embodiments, the method further includes step 361 (not shown in the figure).

Step 361: Dynamically adjust, according to at least one of the historical game behavior and a historical viewing behavior of the user account in the game application, the account tag of the user account and the weight value respectively corresponding to each account tag. For example, the plurality of account tags and the plurality of weight values corresponding to the plurality of account tags are adjusted based on the game play activity information of the user account and viewing behavior information of the user account in the game application.

In some embodiments, the account tag of the user account is dynamically adjusted according to at least one of the historical game behavior and the historical viewing behavior. Because a game behavior habit and a game viewing habit of the user may be constantly changing, to better adapt to the video viewing habit of the user, the account tag, the video tag, the weight value, and the like need to be continuously adjusted.

In the technical solution provided in this embodiment of this disclosure, the account tag of the user account changes. For example, the account tag may be deleted or added. In some embodiments, if a quantity of times of using a first virtual character by the user is once the greatest, but the user does not use the first virtual character for more than third duration, an original account tag of the first virtual character may be deleted. In some embodiments, the third duration is one year. Once the user does not use the first virtual character for more than one year, the client may delete the account tag related to the first virtual character in the original account tag. In some embodiments, as duration from a time point at which the first virtual character is used for a last time to a current moment increases, a weight value of the account tag corresponding to the first virtual character continues to decrease. In some other embodiments, if the game behavior habit of the user changes from “Preferring a middle lane” to “Preferring a jungle”, which needs to be determined with reference to game behavior data of the user in recent N games, the account tag of the user account also changes accordingly. For example, “Novice jungle player” is added to the account tag, and a weight value of the account tag corresponding to “Preferring a middle lane” is reduced, or an account tag corresponding to “Preferring a middle lane” is deleted. Therefore, a video recommended by the client to the user for viewing also changes. In some other embodiments, if a quantity of times of using the virtual character Xiao Qiao is the greatest in recent N battles played by the user, a weight value of the account tag “Player Xiao Qiao” may be increased, where N is a positive integer. In some other embodiments, the game behavior habit of the user does not change, but the viewing habit of the user changes. For example, although the user is a middle lane player, the user wants to learn some jungle skills and operations. Therefore, the viewing habit undergoes major changes. In this case, the account tag also needs to be adjusted, and the weight value also needs to be changed. If the user especially prefers to view a video of an “xx” video releaser recently, a weight value of the video of the “xx” video releaser needs to be adjusted to a highest value, so that the video is recommended to the user for viewing. In other words, the game behavior and the viewing behavior of the user in a period of time directly affect the account tag, and affect a weight corresponding to the account tag. In the technical solution provided in this embodiment of this disclosure, by continuously adjusting the tag and the weight, the recommendation score continuously changes, which is more in line with the viewing habit of the user, and helps improve user viscosity.

In the technical solution provided in this embodiment of this disclosure, the video recommended to the user is determined by setting a recommendation score for the game video in the game video library, where the recommendation score is related to the account tag and the video tag. Therefore, the recommendation score is more in line with the game behavior habit and the video viewing habit of the user. Compared with displaying all videos, recommending videos according to the recommendation score, to recommend videos in a targeted manner is more in line with the viewing requirement of the user, and is more humanized.

In the technical solution provided in this embodiment of this disclosure, determining of the recommendation score is more accurate and more proper by setting different weights for different account tags. If all account tags are set to a same weight, it is impossible to distinguish between primary and secondary. Therefore, the technical solution provided in this embodiment of this disclosure is more proper in design, and the video ultimately recommended to the user is also closer to the requirement of the user. The user does not need to select videos a plurality of times, which helps improve efficiency of video selection.

FIG. 9 is a flowchart of a method for playing a game video according to another embodiment of this disclosure. An execution entity of each step in the method may be the terminal device 10 in the implementation environment of the solution shown in FIG. 1. For example, the execution entity of each step may be a client of a target application in the terminal device 10. In the following method embodiment, for ease of description, a description is made by merely using a “client” as an execution entity of the steps. The method may include at least one of the following steps (310 to 380).

Step 310: Display a video playing interface of a game application, where the video playing interface is a user interface configured to play a game video related to the game application, and a user account is logged in the game application. For example, a video playing interface is displayed in a game application.

Step 320: Display preview information of at least one game video, where the preview information includes personalized prompt information determined based on an account tag of the user account and content of the game video, and the account tag is determined based on a historical game behavior of the user account in the game application. For example, preview information of at least one game video of a game video library is displayed. In an example, the preview information includes description information that is determined based on an account tag of a user account and content of the first game video from the at least one game video. For example, the account tag is determined based on game play activity information of the user account associated with the game application.

Step 330: Play, in response to an operation on a first game video in the at least one game video, the first game video in the video playing interface. For example, based on a user operation performed on the first game video from the at least one game video, the first game video is played in the video playing interface.

Step 310 to step 330 are the same as those introduced in the foregoing embodiments. For content not described in this embodiment of this disclosure, refer to the foregoing embodiments. This is not described herein again.

Step 370: Display, in a process of playing the first game video, at least one purchasable virtual item included in the first game video. For example, when the first game video is being played, at least one purchasable virtual item included in the first game video is displayed.

The virtual item in this embodiment of this disclosure refers to a virtual item related to the game application. In some embodiments, the virtual item may be a skin of a virtual character, accessories of the virtual character, inscriptions/runes corresponding to the virtual character, the virtual character, and any purchasable virtual item. In addition to the virtual item, the client may further display, in a process of playing the first game video, a non-virtual item related to content of the first video, such as a garage kit of the virtual object and other real items related to the virtual object, where the virtual object includes the virtual character, a virtual vehicle, and the like.

In some embodiments, in the process of playing the first game video, the client does not directly display the virtual item or a non-virtual item, but displays a purchase control. In response to an operation of tapping the purchase control performed by the user, the client displays at least one purchasable virtual item or non-virtual item included in the first game video.

As shown in the sub-figure b in FIG. 2, the client displays the purchase control 102 in the process of playing the first game video. In response to the tapping operation of the user on the purchase control 102, the client displays at least one purchasable virtual item or non-virtual item included in the first game video.

In some embodiments, step 370 further includes step 370-1 (not shown in the figure).

Step 370-1: Display, in the process of playing the first game video, the at least one purchasable virtual item included in the first game video if a playing progress reaches a point at which an item is recommended. For example, the at least one purchasable virtual item is displayed when a playback progress of the first game video reaches a predetermined item recommendation timestamp.

The point at which the item is recommended may refer to a specific timestamp corresponding to the game video. In some embodiments, the point at which the item is recommended may be preset, may be set in various manners, or may be determined according to content of the played game video. For example, a dotting position may be used as the point at which the item is recommended.

In the technical solution provided in this embodiment of this disclosure, at least one purchasable virtual item included in the first game video is displayed in a case in which a playing progress reaches the point at which the item is recommended. By giving a real-time item recommendation to the user, it is conducive to increasing a frequency of man-machine interaction, and may further meet a requirement of the user for the virtual item. When the user views a video, if the user is amazed by operating skills of the character in the game video, the user may express support for the game video in a manner of purchasing the virtual item.

In some embodiments, step 370 further includes step 370-2 to step 370-4 (not shown in the figure).

Step 370-2: In the process of playing the first game video, identify, in response to an operation configured for purchasing an item, an image frame currently displayed in the first game video. For example, in response to receiving the item purchase operation, a currently displayed video frame in the first game video is identified.

The foregoing operation may refer to a purchase operation (which may also be referred to as an item purchase operation) of the user for the virtual item. In some embodiments, the item purchase operation may be an operation for the foregoing purchase control. The item purchase operation is an operation of purchasing the virtual item or the non-virtual item performed by the user. Types of the item purchase operation include but are not limited to at least one of the following: tapping, double-tapping, touch-and-hold, and a special gesture.

In some embodiments, identifying an image frame currently displayed in the first game video may be identifying a virtual object in the image frame. An identification result includes but is not limited to at least one of the following: a name of the virtual object, a skin of the virtual object, an attack item of the virtual object, and a virtual vehicle of the virtual object.

Step 370-3: Determine the at least one purchasable virtual item based on a virtual item included in the image frame. For example, the at least one purchasable virtual item is determined based on virtual items included in the identified video frame.

The virtual item included in the image frame includes but is not limited to the foregoing identification result, namely, the name of the virtual object, the skin of the virtual object, the attack item of the virtual object, the virtual vehicle of the virtual object, and the like. For example, the virtual item corresponding to the identification result may be directly determined as at least one purchasable virtual item.

Step 370-4: Display the at least one purchasable virtual item. For example, the determined the at least one purchasable virtual item is displayed.

In some embodiments, in response to the item purchase operation of the user, playing of the first game video is paused. The client displays the identification result, namely, at least one purchasable virtual item, of the current image frame in the video playing interface. Certainly, the client may also not display in the video playing interface, but jump to another purchase interface to display the virtual item. This is not limited in this embodiment of this disclosure.

In the technical solution provided in this embodiment of this disclosure, if the user sees, in a process of viewing the video, the virtual item that the user wants to purchase, the user may perform the item purchase operation. After detecting an operation signal generated by the item purchase operation, the client may identify the image frame currently displayed in the current game video, to display at least one purchasable virtual item. The user may determine, according to the virtual item included in the current image frame, the virtual item that the user wants to purchase. Therefore, real-time requirement of the user may be met, and a design is more proper and humanized.

Step 380: In response to an operation configured for redeeming a first virtual item among the at least one purchasable virtual item, redeem the first virtual item by using virtual resources of the user account, and display a redemption result of the first virtual item. For example, in response to receiving an item purchase operation for a first virtual item from the at least one purchasable virtual item, the first virtual item is purchased using virtual resources of the user account and a purchase completion result of the first virtual item is displayed.

The foregoing operation may refer to a redemption operation of the user for the virtual item. The redemption operation is configured for obtaining the first virtual item. The first virtual item may refer to a virtual item selected by the user. Redemption of the virtual item corresponds to a redemption control, and the redemption operation may refer to an operation on the redemption control. In some embodiments, the foregoing redemption operation may be at least one of tapping, touch-and-hold, a gesture, and the like.

The virtual resources include but are not limited to at least one of the following: a virtual gold coin, a virtual fragment, a virtual crystal, a virtual box, and a virtual diamond.

The redemption result may be displayed as the virtual item in the center of the video playing interface, with a prompt “Congratulations on obtaining xxx”. If the non-virtual item is purchased, the redemption result may be further “Payment succeeds, please check in an order”. The redemption result may be further displayed in another manner. This is not limited in this embodiment of this disclosure.

In the technical solution provided in this embodiment of this disclosure, by displaying the purchasable virtual item in a process of playing the game video, the user may redeem the virtual item by using the virtual resources, which enriches a manner of man-machine interaction, improves fun of video playing, and also meets a purchasing requirement of the user.

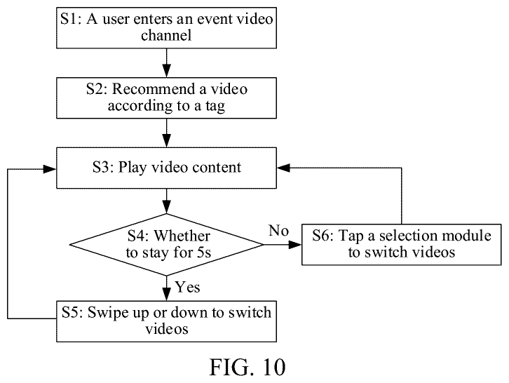

FIG. 10 is a schematic diagram of a method for playing a game video according to an embodiment of this disclosure. An execution entity of each step in the method may be the terminal device 10 in the implementation environment of the solution shown in FIG. 1. For example, the execution entity of each step may be a client of a target application in the terminal device 10. In the following method embodiment, for ease of description, a description is made by merely using a “client” as an execution entity of the steps. The method may include at least one of the following steps (S1 to S6).

### Step S1: A User Enters an Event Video Channel.

In some embodiments, a user interface of a game application displays a plurality of column options, and different column options correspond to different channels, such as a video channel, and a live stream channel. The video channel may include the event video channel, a video viewing channel, and the like. For example, the client displays a video playing interface of the game application in response to an operation for triggering the video channel of the game application. For example, the client displays, in response to a trigger operation of the user on the event video channel, a video playing interface corresponding to the event video channel. In some embodiments, the video playing interface may be supported by an event video player, that is, the user enters the event video player.

### Step S2: Recommend a Video According to a Tag.

An account tag is generated according to a historical viewing behavior, a historical game behavior, and the like of the user, video content is recommended based on the account tag, and a video content playing state is automatically entered. For the same video, for a user who prefers an x virtual character, a title of the video includes content of the x virtual character, or prompts a highlight moment of the x virtual character. For a player who prefers a middle lane, a title or a prompt preferred by the user is accordingly displayed. When a switching behavior of the user occurs, a video that is the same as or similar to a current video tag is switched for playing.

For example, a third game video is played in full screen in the foregoing video playing interface. The third game video is a game video selected from a game video library based on the account tag. That is, every time the user enters the event video channel, the client automatically shows, according to the account tag of the user account, the third game video that the user may be interested in to the user, and the user does not need to decide to select which game video. In addition, the third game video is played in full screen, so that the user can view the game video in an immersive manner, which helps increase user viscosity.

### Step S3: Play Video Content.

In some embodiments, the client automatically plays the third game video. The user may switch video content by actively tapping a video list (namely, preview information) on a right side. For example, in response to an operation on the first game video, the client switches the third game video to the first game video for playing. The operation may refer to a trigger operation on preview information corresponding to the first game video in the video list. In this way, there is no need to exit the current video playing interface, which helps improve efficiency of video switching.

### Step S4: Whether to Stay for 5 s.

If stay duration exceeds 5 s, step S5 is performed. If the stay duration does not reach 5 s, step S6 is performed. That is, the client detects that duration in which the user does not perform an operation exceeds 5 s, and then step S5 is performed.

### Step S5: Swipe Up or Down to Switch Videos.

When a switching operation of the user occurs, a video that is the same as or similar to a current video tag is switched for playing. For example, in response to a switching operation on the first game video, the client switches the third game video to the first game video for playing. The switching operation may refer to a swiping up or down operation on the third game video. In this way, there is no need to exit the current video playing interface, which helps improve efficiency of video switching. The first game video may be a video the same as or similar to the current video tag.

### Step S6: Tap a Selection Module to Switch Videos.

In other words, the user may switch game video through the preview information in the video list.

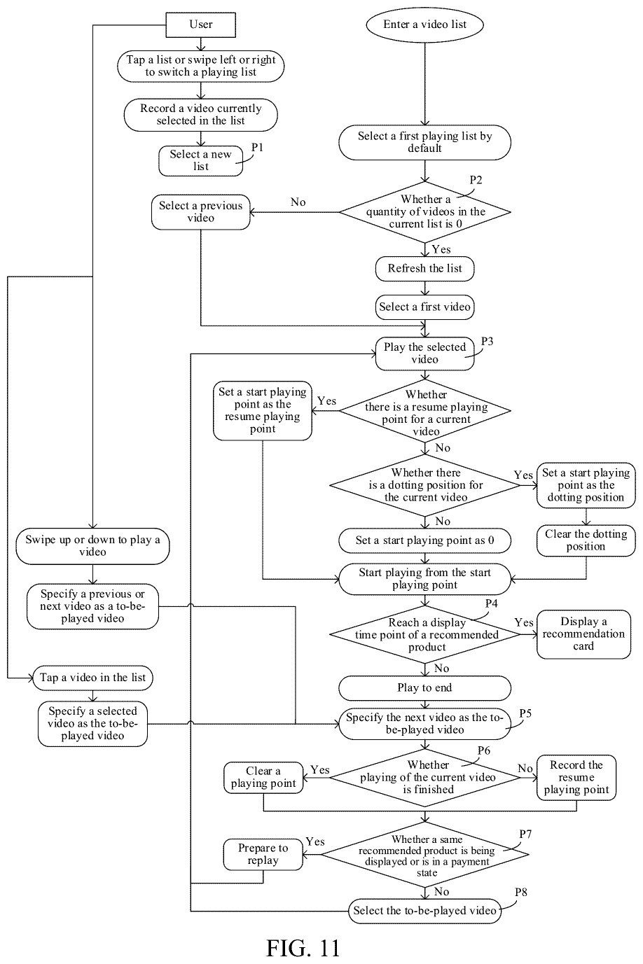

FIG. 11 is a schematic diagram of a method for playing a game video according to another embodiment of this disclosure. The method may include at least one of the following steps (P1 to P8).

### Step P1: Select a New List.

In this embodiment of this disclosure, preview information may be displayed in a form of different lists, that is, corresponding to different lists, there is preview information of different game videos. In some embodiments, a first list may be determined in various manners by a server, or may include preview information corresponding to a game video with a high recommendation score. This is not limited in this embodiment of this disclosure. In some embodiments, when a user taps the list or swipes left or right to switch a playing list, a client records a video selected in a current list, and selects a new list, that is, updates the list or updates the preview information in the list.

In some embodiments, the client may simultaneously display a plurality of lists. For example, the plurality of lists may be divided into columns such as “popular”, “latest”, and “classic”, and the user may select a column as required.

### Step P2: Whether a Quantity of Videos in the Current List is 0.

When the client enters the video list (such as displayed in a style of a preview information list), a first playing list is selected by default. For example, the client plays, by default, the game video by using the first playing list. The client updates the playing list in response to the operations of the user such as changing and refreshing the playing list. In some embodiments, the client further determines whether the quantity of videos in the current list is 0. If the quantity of videos in the current list is 0, the list is refreshed. If the quantity of videos in the current list is not 0, a last video is selected for playing. If the list is refreshed, a first video is selected, and then step P3 is performed.

### Step P3: Play the Selected Video.

The client determines whether there is a resume playing point in the current video. If there is a resume playing point, the resume playing point is used as a start playing point. If there is no resume playing point, it is determined whether there is a dotting position in the current video. If there is a dotting position in the current video, the start playing point is set as the dotting position, and an original dotting position is cleared. If there is no dotting position in the current video, the start playing point is set to a 0 moment of the video. Finally, the video starts playing from the start playing point.

### Step P4: Reach a Display Time Point of a Recommended Product.

The client determines whether the display time point of the recommended product is reached, that is, a recommended purchase time point of a virtual item. If yes, a recommendation card is displayed for the user to purchase the virtual item. If not, the video is played until playing of the video is ended.

Step P5: Specify a Next Video as a to-be-Played Video.

The user may swipe up or down to play a video, and specify a previous or next video as the to-be-played video. In addition, the user may tap the video in the list, and specify the video in the list as the to-be-played video.

The user taps the video in the list.

### Step P6: Whether Playing of the Current Video is Finished.

The client determines whether playing of the current video is finished. If yes, a playing point in the video is cleared. If not, a last playing moment is recorded as the resume playing point. In other words, the next time the user swipes to the video or selects the video, the client may continue playing the video from the resume playing point.

Step P7: Whether the Same Recommended Product is being Displayed or is in a Payment State.

The client determines whether the same recommended product is being displayed or is in a payment state. If yes, the client prepares to replay the current video. If not, the client selects the to-be-played video and performs step P8.

Step P8: Select the to-be-Played Video.

After selecting the to-be-played video, the client continues to play the selected video.

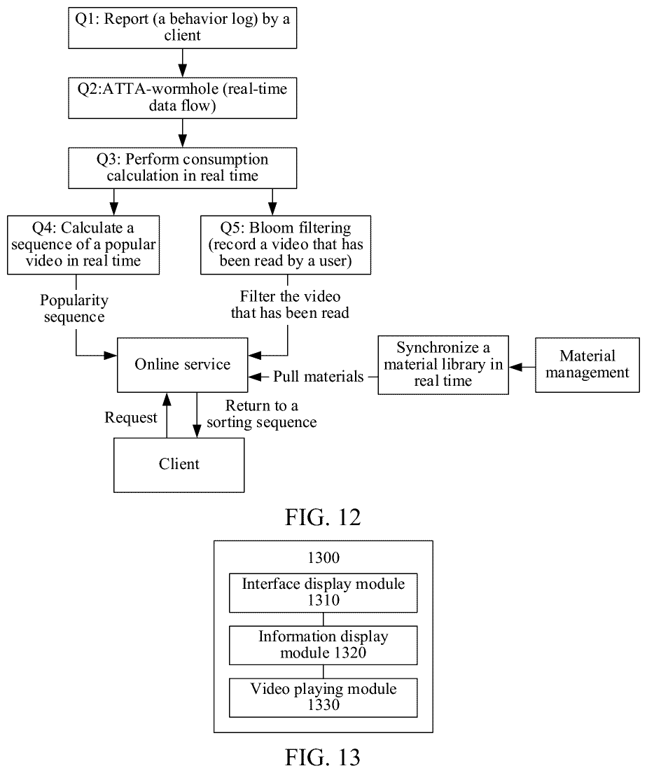

FIG. 12 is a schematic diagram of a method for playing a game video according to another embodiment of this disclosure. An execution entity of each step of the method may be a server 20 in the implementation environment shown in FIG. 1. In the following method embodiment, for ease of description, a description is made by merely using a “server” as an execution entity of the steps. The method may include at least one of the following steps (Q1 to Q5).

### Step Q1: Receive a Behavior Log Reported by a Client.

The behavior log includes historical game behavior data, historical viewing behavior data, historical consumption behavior data, and the like of a user.

### Step Q2: Receive a Real-Time Data Flow.

The real-time data flow may refer to an operation signal generated by a real-time operation of the user.

### Step Q3: Perform Consumption Calculation in Real Time.

Perform consumption calculation in real time by using Flink.

### Step Q4: Calculate a Sequence of a Popular Video in Real Time.

In other words, popularity of each game video is determined in real time, and game videos are sorted according to the popularity, to recommend a more popular game video to the user.

Step Q5: Perform Bloom Filtering. In Other Words, a Video that has been Played by the User is Filtered Out.

In addition, the server performs material (namely, game videos) management, synchronizes a material library in real time, and pulls materials. The server sends, according to a popularity sequence of the video, the video that has been played by the user, and the like, a video sorting sequence to the client when the client requests a video sequence.

In some embodiments, the server may further calculate a recommendation score of the video according to a video tag, an account tag, and a weight value of a tag, and send the video sequence to the client based on the recommendation score.

In this embodiment of this disclosure, an entity of determining the account tag, the video tag, and the weight of the tag may be a terminal device, or a client or a server of a game application. The same applies to dynamic adjustment of the tag. The entity of determining or adjusting the tag is not limited in this disclosure. In some embodiments, the client determines the account tag according to the historical game behavior or the historical viewing behavior of the user, and further generates personalized prompt information, to display different preview information in a targeted manner to users with different account tags.

The following is an apparatus embodiment of this disclosure, which may be used to perform the method embodiments of this disclosure. For details not disclosed in the apparatus embodiments of this disclosure, refer to the method embodiments of this disclosure.

FIG. 13 is a block diagram of an apparatus for playing a game video according to an embodiment of this disclosure. The apparatus has functions of implementing the foregoing method embodiments. The functions may be implemented by hardware, or may be implemented by hardware executing corresponding software. The apparatus may be the terminal device described above, or may be arranged on the terminal device. As shown in FIG. 13, the apparatus 1300 may include: an interface display module 1310, an information display module 1320, and a video playing module 1330.

The interface display module 1310 is configured to display a video playing interface of a game application, the video playing interface being a user interface configured to play a game video related to the game application, and a user account being logged in the game application.

The information display module 1320 is configured to display preview information of at least one game video, the preview information including personalized prompt information determined based on an account tag of the user account and content of the game video, and the account tag being determined based on a historical game behavior of the user account in the game application.

The video playing module 1330 is configured to play, in response to an operation on a first game video in the at least one game video, the first game video in the video playing interface.

In some embodiments, the personalized prompt information is displayed in a form of a recommendation tag of the game video; or the personalized prompt information is displayed in a form of a video title of the game video; or the personalized prompt information is displayed in a form of a preview of the game video.

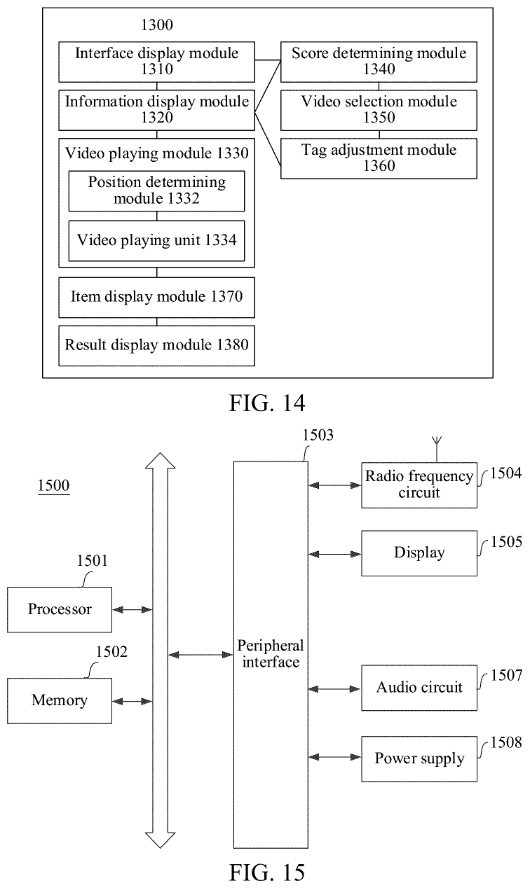

In some embodiments, as shown in FIG. 14, the video playing module 1330 includes a position determining unit 1332 and a video playing unit 1334.

The position determining unit 1332 is configured to determine a first dotting position from at least one dotting position in the first game video, where the dotting position refers to a position of a key frame in the first game video.

The video playing unit 1334 is configured to play the first game video starting from a key frame corresponding to the first dotting position.

In some embodiments, the position determining unit 1332 is configured to select, according to content information of each dotting position in the first game video, a dotting position that matches the account tag as the first dotting position, where the content information indicates content of a video clip corresponding to the dotting position.

In some embodiments, the video playing unit 1334 is further configured to: after playing of the video clip corresponding to the first dotting position is finished, play, starting from a key frame corresponding to a second dotting position in the first game video, a video clip corresponding to the second dotting position.

In some embodiments, the video playing module 1330 is further configured to play a second game video in the video playing interface in response to an operation configured for switching the first game video, where the second game video is a game video selected from a game video library based on the account tag.

In some embodiments, the interface display module 1310 is configured to display the video playing interface of the game application in response to an operation configured for triggering a video channel of the game application, where a third game video is played in full screen in the video playing interface, and the third game video is a game video selected from the game video library based on the account tag.

The video playing module 1330 is further configured to switch, in response to the operation on the first game video, the third game video to the first game video for playing.

In some embodiments, as shown in FIG. 14, the apparatus further includes a score determining module 1340 and a video selection module 1350.

The score determining module 1340 is configured to determine a recommendation score of each game video according to the account tag of the user account and a video tag of at least one game video in the game video library.

The video selection module 1350 is configured to select, from the game video library according to the recommendation score, a game video recommended to the user account, where the recommended game video is configured for displaying preview information, or being switched for playing.

In some embodiments, a quantity of account tags is more than one, and the account tags have corresponding weight values.

In some embodiments, as shown in FIG. 14, the apparatus further includes a tag adjustment module 1360.

The tag adjustment module 1360 is configured to dynamically adjust, according to at least one of the historical game behavior and a historical viewing behavior of the user account in the game application, the account tag of the user account and the weight value respectively corresponding to each account tag.

The score determining module 1340 is configured to determine the recommendation score of each game video according to the account tag of the user account, the weight value respectively corresponding to each account tag, and the video tag of the at least one game video in the game video library.

In some embodiments, as shown in FIG. 14, the apparatus further includes an item display module 1370 and a result display module 1380.

The item display module 1370 is configured to display, in a process of playing the first game video, at least one purchasable virtual item included in the first game video; and

The result display module 1380 is configured to: in response to an operation configured for redeeming a first virtual item among the at least one purchasable virtual item, redeem the first virtual item by using virtual resources of the user account, and display a redemption result of the first virtual item.

In some embodiments, the item display module 1370 is configured to display, in the process of playing the first game video, the at least one purchasable virtual item included in the first game video if a playing progress reaches a point at which an item is recommended.

In some embodiments, the item display module 1370 is configured to: in the process of playing the first game video, identify, in response to an operation configured for purchasing an item, an image frame currently displayed in the first game video.

In some embodiments, the item display module 1370 is configured to determine the at least one purchasable virtual item based on a virtual item included in the image frame.

In some embodiments, the item display module 1370 is configured to display the at least one purchasable virtual item.

In the technical solution provided in this embodiment of this disclosure, by displaying the preview information of the game video in the video playing interface, the preview information includes the personalized prompt information determined based on the account tag of the user account and the content of the game video. When the user preforms an operation on the game video according to the preview information, the game video may be played in the video playing interface. In the technical solutions provided in the embodiments of this disclosure, because the personalized prompt information is determined based on the account tag of the user account and the content of the game video, that is, for different user accounts with different account tags, the client generates and displays different personalized prompt information (even for the same game video) based on different account tags, instead of displaying the same prompt information, thereby improving display flexibility and rationality of the prompt information. In addition, the personalized prompt information may better prompt the user, be more relevant to the user, and give the user better viewing guidance, thereby helping improve user viscosity, and also enriching a display form of the preview information.

When the apparatus provided in the foregoing embodiments implements functions of the apparatus, it is illustrated with an example of division of each functional module. In the practical application, the function distribution may be finished by different functional modules according to the requirements, that is, the internal structure of the device is divided into different functional modules, to implement all or some of the functions described above. In addition, the apparatus and method embodiments provided in the foregoing embodiments belong to one conception. For the specific implementation process, refer to the method embodiments, and details are not described herein again.

FIG. 15 is a structural block diagram of a terminal device 1500 according to an embodiment of this disclosure. The terminal device 1500 may be a terminal device 10 in the implementation environment shown in FIG. 1, and is configured to implement the method for playing the game video provided in the foregoing embodiment. Specifically,

The terminal device 1500 includes a processor 1501 (e.g., processing circuitry) and a memory 1502 (e.g., a non-transitory computer-readable storage medium).

The processor 1501 may include one or more processing cores, for example, a 4-core processor or an 8-core processor. The processor 1501 may be implemented by using at least one hardware form of a digital signal processor (DSP), a field programmable gate array (FPGA), and a programmable logic array (PLA). The processor 1501 may also include a main processor and a coprocessor. The main processor is a processor configured to process data in an awake state, and is also referred to as a central processing unit (CPU). The coprocessor is a low power consumption processor configured to process the data in a standby state. In some embodiments, the processor 1501 may be integrated with a graphics processing unit (GPU). The GPU is configured to be responsible for rendering and drawing content that a display needs to display. In some embodiments, the processor 1501 may further include an artificial intelligence (AI) processor. The AI processor is configured to process computing operations related to machine learning.

The memory 1502 may include one or more computer-readable storage media that may be non-transitory. The memory 1502 may further include a high-speed random access memory and a non-volatile memory, such as one or more magnetic disk storage devices or flash storage devices. In some embodiments, the non-transient computer-readable storage medium in the memory 1502 is configured to store a computer program, and the computer program is executed by one or more processors, to implement the method for playing the game video.

In some embodiments, the terminal device 1500 may alternatively include: a peripheral interface 1503 and at least one peripheral. The processor 1501, the memory 1502, and the peripheral interface 1503 may be connected through a bus or a signal cable. Each peripheral may be connected to the peripheral interface 1503 through a bus, a signal cable, or a circuit board. Specifically, the peripheral includes: at least one of a radio frequency circuit 1504, a display screen 1505, an audio circuit 1507, and a power supply 1508.

A person skilled in the art may understand that the structure shown in FIG. 15 does not constitute a limitation on the terminal device 1500 and that the terminal device may include more or fewer assemblies than those shown in the figure, a combination of some assemblies, or different assembly arrangements.

In an embodiment, a computer-readable storage medium, such as a non-transitory computer-readable storage medium is further provided, the storage medium storing a computer program, the computer program, when executed by a processor, implementing the method for playing the game video.

In some embodiments, the computer-readable storage medium may include: a read-only memory (ROM), a random-access memory (RAM), a solid-state drive (SSD), an optical disc, or the like. The random-access memory may include a resistance random access memory (ReRAM) and a dynamic random access memory (DRAM).

In an embodiment, a computer program product is further provided, the computer program product including a computer program, and the computer program being stored in a computer-readable storage medium. A processor of a terminal device reads the computer program from the computer-readable storage medium, and executes the computer program, to enable the terminal device to perform the method for playing the game video.

It is to be understood that “plurality of” mentioned in the specification means two or more. “And/or” describes an association relationship for describing associated objects and represents that three relationships may exist. For example, A and/or B may represent the following three cases: only A exists, both A and B exist, and only B exists. The character “/” in this specification indicates an “or” relationship between the associated objects. In addition, the step numbers described in this specification are merely used as examples to show a possible execution sequence of the steps. In some other embodiments, the steps may not be performed according to the number sequence. For example, two steps with different numbers may be performed simultaneously, or two steps with different numbers may be performed according to a sequence contrary to the sequence shown in the figure. This is not limited in this embodiment of this disclosure.

The foregoing descriptions are merely some embodiments of this disclosure, and are not intended to limit this disclosure. Any modification, equivalent replacement, or improvement made within the spirit and principle of this disclosure shall fall within the protection scope of this disclosure.

What is claimed is:

1. A method for playing a first game video, the method comprising:
displaying a video playing interface in a game application;
displaying preview information of at least one game video of a game video library, the preview information including description information that is determined based on an account tag of a user account and content of the first game video from the at least one game video, the account tag being determined based on game play activity information of the user account associated with the game application; and
based on a user operation being performed on the first game video from the at least one game video, playing the first game video in the video playing interface.

2. The method according to claim 1, further comprising:
generating the account tag based on the game play activity information, the game play activity information indicating at least one of:
a number of times a virtual character has been used,
a number of times a virtual item has been used,
a number of games played in different game positions, or
achievement scores associated with different virtual characters.

3. The method according to claim 1, wherein
the description information is displayed in at least one of
a recommendation tag format associated with the first game video;
a video title format associated with the first game video; or
a preview image format associated with the first game video.

4. The method according to claim 1, wherein the playing the first game video comprises:
determining a first key frame from at least one key frame in the first game video; and
playing the first game video from the first key frame.

5. The method according to claim 4, wherein the determining the first key frame comprises:
selecting, as the first key frame, a key frame from the at least one key frame that matches the account tag based on content information of each of the at least one key frame in the first game video.

6. The method according to claim 4, further comprising:
after completing playback for a first video segment corresponding to the first key frame, automatically selecting a second key frame based on at least one of a time sequence order, a content importance score, or a degree of correlation with the account tag; and
playing a second video segment corresponding to the second key frame in the first game video from the second key frame while skipping intervening video content between the first key frame and the second key frame.

7. The method according to claim 1, wherein the displaying the video playing interface comprises:
selecting a video channel in the game application;
displaying the video playing interface of the game application;
playing a third game video in a full screen mode in the video playing interface, the third game video being selected from the game video library based on the account tag;
based on the user operation being performed on the first game video, cancelling the playing of the third game video in the video playing interface; and
playing the first game video in the video playing interface.

8. The method according to claim 1, further comprising:
determining recommendation scores for a plurality of game videos in the game video library by, for each game video of the plurality of game videos:
determining a correlation between video information for the respective game video and the account tag of the user account, and
determining a recommendation score for the respective game video based on the correlation;
selecting at least one recommended game video from the game video library based on the recommendation scores; and
displaying the preview information for the selected at least one recommended game video in the video playing interface.

9. The method according to claim 8, wherein the user account is associated with a plurality of account tags respectively corresponding to a plurality of weight values.

10. The method according to claim 9, further comprising:
adjusting the plurality of account tags and the plurality of weight values corresponding to the plurality of account tags based on the game play activity information of the user account and viewing behavior information of the user account in the game application; and
determining the recommendation scores for the plurality of game videos based on the adjusted plurality of account tags, the adjusted plurality of weight values, and the video information associated with the plurality of game videos in the game video library.

11. The method according to claim 1, further comprising:
when the first game video is being played, displaying at least one purchasable virtual item included in the first game video; and
in response to receiving an item purchase operation for a first virtual item from the at least one purchasable virtual item, purchasing the first virtual item using virtual resources of the user account and displaying a purchase completion result of the first virtual item.

12. The method according to claim 11, wherein the displaying the at least one purchasable virtual item comprises:
displaying the at least one purchasable virtual item when a playback progress of the first game video reaches a predetermined item recommendation timestamp.

13. The method according to claim 11, wherein the displaying the at least one purchasable virtual item comprises:
in response to receiving the item purchase operation, identifying a currently displayed video frame in the first game video;
determining the at least one purchasable virtual item based on virtual items included in the identified video frame; and
displaying the determined the at least one purchasable virtual item.

14. An apparatus, comprising:
processing circuitry configured to:
display a video playing interface in a game application;
display preview information of at least one game video of a game video library, the preview information including description information that is determined based on an account tag of a user account and content of a first game video from the at least one game video, the account tag being determined based on game play activity information of the user account associated with the game application; and
based on a user operation being performed on the first game video from the at least one game video, play the first game video in the video playing interface.

15. The apparatus according to claim 14, wherein the processing circuitry is configured to:
generate the account tag based on the game play activity information, the game play activity information indicating at least one of:
a number of times a virtual character has been used,
a number of times a virtual item has been used,
a number of games played in different game positions, or
achievement scores associated with different virtual characters.

16. The apparatus according to claim 14, wherein the description information is displayed in at least one of:
a recommendation tag format associated with the first game video;
a video title format associated with the first game video; or
a preview image format associated with the first game video.

17. The apparatus according to claim 14, wherein the processing circuitry is configured to:
determine a first key frame from at least one key frame in the first game video; and
play the first game video from the first key frame.

18. The apparatus according to claim 17, wherein the processing circuitry is configured to:
select, as the first key frame, a key frame from the at least one key frame that matches the account tag based on content information of each of the at least one key frame in the first game video.

19. The apparatus according to claim 17, wherein the processing circuitry is configured to:
after playback for a first video segment corresponding to the first key frame is completed,
automatically select a second key frame based on at least one of a time sequence order, a content importance score, or a degree of correlation with the account tag; and
play a second video segment corresponding to the second key frame in the first game video from the second key frame while skipping intervening video content between the first key frame and the second key frame.

20. A non-transitory computer-readable storage medium, storing instructions which when executed by a processor cause the processor to perform:
displaying a video playing interface in a game application;
displaying preview information of at least one game video of a game video library, the preview information including description information that is determined based on an account tag of a user account and content of a first game video from the at least one game video, the account tag being determined based on game play activity information of the user account associated with the game application; and
based on a user operation being performed on the first game video from the at least one game video, playing the first game video in the video playing interface.
